(19) United States
(12) Patent Application Publication
(10) Pub. No.: US 2010/0017716 A1
(43) Pub. Date: Jan. 21, 2010

(54) METHOD AND APPARATUS FOR GENERATING A SUMMARY

(75) Inventors: Johannes Weda, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,554

(22) PCT Filed: Aug. 24, 2007
(86) PCT No.: PCT/IB07/53395

§ 371 Date: Feb. 24, 2009

(30) Foreign Application Priority Data
Aug. 25, 2006 (EP) 06119533.5

(51) Int. Cl. G06F 3/01

(52) U.S. Cl. 715/719

(57) ABSTRACT

A method and apparatus for generating a summary of a plurality of distinct data streams (for example video data streams). A plurality of related data streams are collected. The data streams comprise a plurality of segments and each segment is synchronized (205). Overlapping segments of the synchronized data streams are detected (207, 309) and one the overlapping segments is selected (215) to generate a summary (217) which includes the selected overlapping segment.

### FIELD OF THE INVENTION

The present invention relates to generation of a summary from a plurality of data streams. In particular, but not exclusively, it relates to generation of a summary of available video material of an event.

### BACKGROUND OF THE INVENTION

Recently camcorders have become much cheaper, thereby allowing a larger audience to easily record all kind of occasions and events. Additionally an increasing amount of cell phones are equipped with embedded cameras. Therefore video recordings become readily and effortlessly available.

This allows people to record many events, like vacations, picnics, birthdays, parties, weddings, etc. It has become a social practice to record these kinds of events. Therefore, invariably, the same event is recorded by multiple cameras. These cameras may be those carried by people attending the event or other fixed or embedded cameras such as those, for example, intended for recording the surroundings for security or surveillance reasons or events in theme parks etc. Every participant of such an event would like to have the best video record of that event, according to his interest.

For photos it has already become customary to share and/or publish them via the Internet. There exist several Internet services for this purpose. The exchange of digital images also takes place through the exchange of physical media, e.g. optical discs, tapes, portable USB sticks, etc. Due to the bulky nature of the video data stream, video is difficult to access, split, edit and share. Therefore the sharing of video material is usually limited to the exchange of discs etc.

In the case of photographs taken at an event, it is relatively easy to edit them, find duplicates, and exchange shots between multiple users. However, video is a massive stream of data, which is difficult to access, split, edit (multi-stream editing), extract parts from and share. It is very cumbersome and time consuming to edit all the material such that a participant gets his own personal video record of the event, to share and to exchange all the recorded material among the participants.

There exists provision of collaborative editors for allowing multiple users to edit several video recordings through the Internet. However, this service is intended for experienced users, and requires considerable knowledge and skill to be able to work with it.

### SUMMARY OF THE INVENTION

Therefore, it would be desirable to provide an automatic system for generating a summary of an event, for example, a video recording of an event.

This is achieved according to a first aspect of the present invention, by a method of generating a summary of a plurality of distinct data streams, the method comprising the steps of: synchronizing a plurality of related data streams, said data streams comprising a plurality of segments; detecting overlapping segments of said synchronized data streams; selecting one of said overlapping segments; and generating a summary including said selected one of said overlapping segments.

This is also achieved according to a second aspect of the present invention, by apparatus for generating a summary of a plurality of distinct data streams, the apparatus comprising: synchronizing means for synchronizing a plurality of related data streams, said data steams comprising a plurality of segments; detector for detecting overlapping segments of said synchronized data streams; selection means for selecting one of said overlapping segments; and means for generating a summary including said selected one of said overlapping segments.

The overlapping segments that are not selected are omitted from the summary. A distinct data stream is a stream of data having a start and finish. In a preferred embodiment the data stream is a video data stream and a distinct video data stream is a single, continuous recording. In a preferred embodiment, related data streams are video recordings taken at the same event. It can be appreciated that although the summary includes one of the overlapping segment, it may also include segments that have no overlap to give a more complete record of an event.

In this way all material (in the particular example, video material) of an event can be collected. The material, or data stream is segmented, for example the data stream may be segmented into natural entities, such an entity may be a shot (continuous camera recording in the case of a video stream) or a scene (group of shots naturally belonging together, e.g. same time, same place, etc.). The data stream is then synchronized such that overlapping segments can be detected, for example, recordings that are made at the same time. Redundancy in the overlapping segments can then be detected, for example recordings that contain the same scene. The summary is then generated from a selection taken from overlapping/redundant segments.

Synchronization of the related data streams may be made by alignment of the streams in time or by virtue of a trigger. The trigger may be a change in at least one parameter of the data streams. For example, the trigger may be a change in scene or shot or load noise, such as canon fire, a whistle or recognition of an announcement etc. Alternatively, the trigger may be a wireless transmission between the capturing devices at the event. Therefore, the capturing devices need not, necessarily, be synchronized to a central clock.

The overlapping/redundant segments may be selected according to a number of criteria such as, for example, signal quality (audio, noise, blur, shaken camera, contrast, etc.), aesthetic quality (angle, optimal framing, composition, tilted horizon, etc.), content and events (main characters, face detection/recognition, etc.), the source of the recording (owner, cameraman, cost and availability, etc.) and personal preference profile. Therefore, the composition of the video summary can be personalized for each user.

By automating these aspects the users save a lot of time in editing and inspecting the raw material.

The invention is described here for video content, but in general the same method can also be applied to digital photograph collections. Moreover, the invention is not limited to audiovisual data only but can also be applied to multimedia streams including other sensor data, like place, time, temperature, physiological data, etc.

### BRIEF DESCRIPTION OF DRAWINGS

For a more complete understanding of the present invention, reference is now made to the following description taken in conjunction with the accompanying drawings, in which:

FIG. 1 is a simple schematic overview of the system according to an embodiment of the present invention;

FIG. 2 is a flow chart of the method steps according to an embodiment of the present invention;

FIG. 3 is a first example of editing of material according to the method steps of the embodiment of the present invention;

FIG. 4 is a second example of editing of material according to the method steps of the embodiment of the present invention; and

FIG. 5 is a third example of editing of material according to the method steps of the embodiment of the present invention.

### DETAILED DESCRIPTION OF EMBODIMENTS OF THE INVENTION

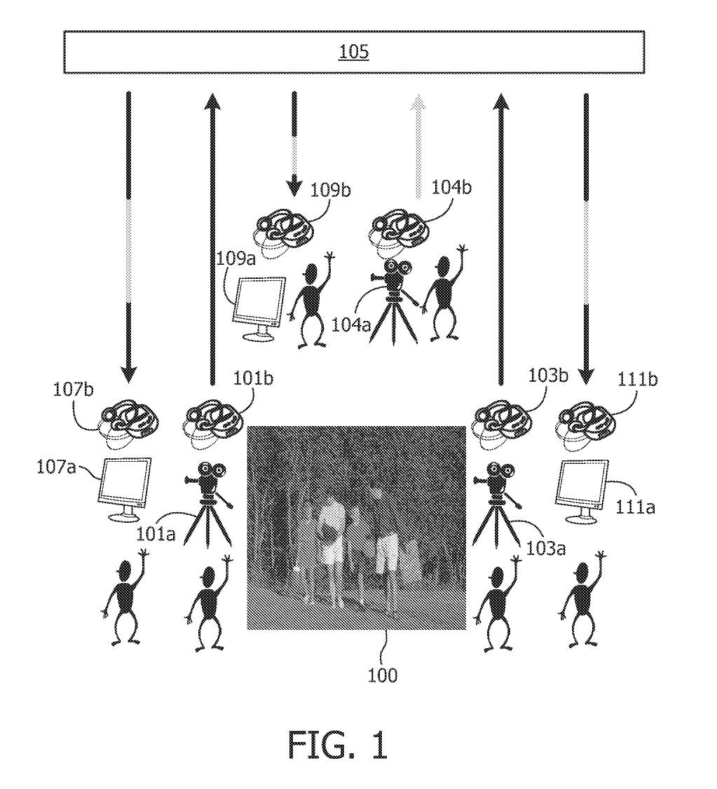

With reference to FIG. 1, some of the participants of an event is shown in an image 100 have recorded the event with a number of cameras and/or audio devices 101a, 101b, 103a, 103b, 104a, 104b. The recordings (or data streams) are submitted to a central (internet) server 105. Here, the material generated at the event is analyzed, a combined final version (or summary) is provided. This combined final version is sent back to the participant via audio, visual and/or computer systems 107a, 107b, 109a, 109b, 111a, 111b. Although the system illustrated in FIG. 1 is a central system, it can be appreciated that a more decentralized or completely decentralized system can also be implemented.

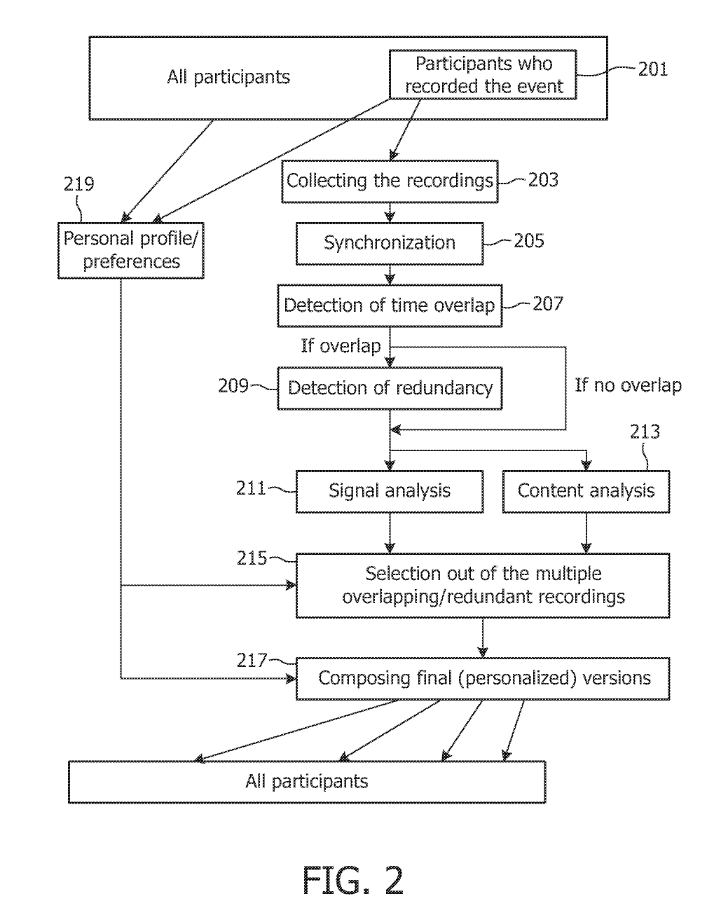

The method steps of an embodiment of the present invention is shown in FIG. 2.

Multiple participants or fixed or embedded cameras at an event make their own recordings, step 201. The recorded material is submitted. This can be done using standard Internet communication technology and in a secure way.

Next, all related data streams received in step 203, i.e. recording material taken at the same event is subsequently put on a common time scale, step 205. This can be done on the basis of the time stamps embedded in the data streams (generated by the capturing devices). These can be aligned with sufficient precision. In case of recordings made by cameras embedded in cell phones, the internal clock is usually automatically synchronized with some central clock. In this case material gathered by cell phones will have internal time stamps that are fairly accurately synchronized with each other. Otherwise, the users have to align the clocks of their capturing device, manually in advance of the event.

Alternatively, the data streams can be synchronized by a trigger, for example, a common scene, sounds etc. or the capturing device may generate a trigger such as an infrared signal which is transmitted between the devices.

Next overlapping segments are detected, step 207. For each segment that overlaps, redundancy between the overlapping segments is detected, step 209. Redundancy means that multiple cameras have taken the same shot, such that the resulting recordings have (partly) the same content. So if there is time overlap, the system compares the multiple related data streams, and searches for redundancy in the overlapping parts, step 209. Redundancy can be detected using frame difference, color, histogram difference, correlation, higher-level metadata/annotations (e.g. textual description of what, who, where, objects in the pictures, etc.), GPS-information with a compass direction on the camera etc. For the accompanying video one can use correlation and/or fingerprinting to detect redundancy.

Note that it is possible to have redundancy without overlapping in time (e.g. recording of a landscape that does not change considerably in time). However to speed-up the analysis, redundancy detection in the preferred embodiment is limited to the segments with time overlapping.

Selection is then made from the overlapping/redundant data streams, step 215. Here, a decision is made on which data stream has priority, for example which recording is to be selected for the summary (or final combined version), step 217. This can be done manually or automatically.

There are numerous criteria which can be taken into account for selecting the segments for the summary, for example, only the “best” data stream may be selected. The qualification ‘best’ can be based on signal quality, aesthetic quality, people in the image, amount of action, etc. It may also consider personal preferences which have been input by the users at step 219. The summary is then shown such that the “best” data stream is selected. Alternately, the summary is shown using the best data streams and other versions of the summary are added as hyperlink (they will be shown only if the users selects them during reproduction).

The system can have default settings for giving priority that can be overruled by personal settings specified in a user profile.

To enable selection of the “best” recording, each segment (or time slot) of the recordings is analyzed on the basis of signal quality (audio, noise, blur, contrast, shaken camera etc.), aesthetic quality (optimal framing, angle, tilted horizon, etc.), people in the video (face detection/recognition) and/or action (movement, audio loudness, etc.).

Subsequently each segment of the related data streams are given a numerical value accordingly, known as a priority score. The decision of which segments are to be included in the summary can then be based on this score.

Note that the same method can be applied to the accompanying audio channel (or 2 channels in case of a stereo signal) that can be selected independently. For overlapping recordings, redundancy in the audio channel can be detected, for example, signal difference, or the audio fingerprints of the multiple recordings. Preferably the audio signal corresponding to the selected video is chosen. However, if there is good alignment (audio may be up to 60 milliseconds behind the video without the users noticing it) the audio with the best quality is selected for the final version, for example that having the higher priority score.

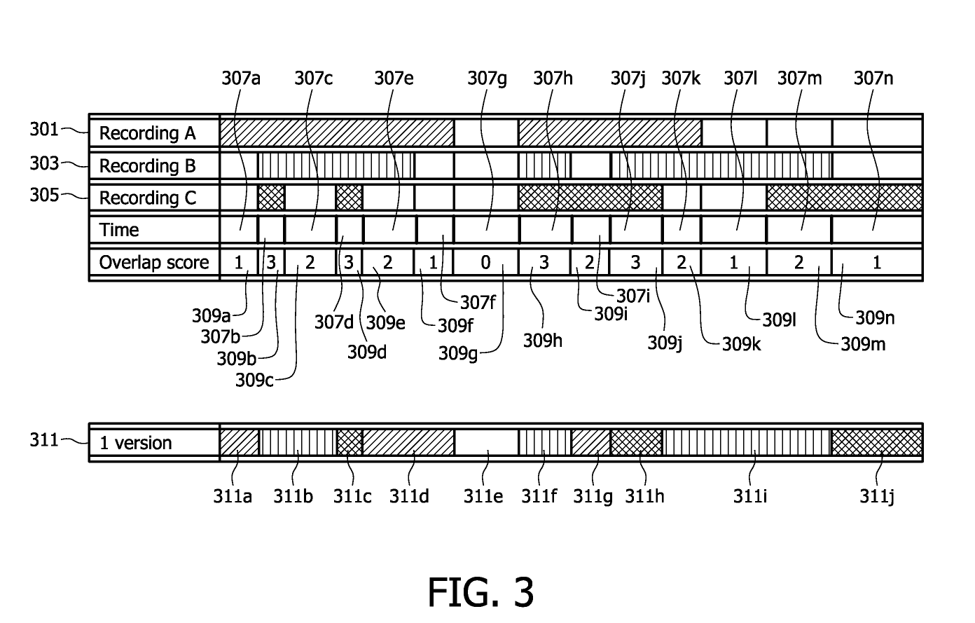

To clarify the step of composing the summary, some examples are shown in FIGS. 3 to 5.

The Example, shown in FIG. 3, is a very simple example. The user is always provided with the best (signal) quality available for each segment independently of the actual content of the various streams. In the Example, first, second and third recordings 301, 303, 305 are made (data streams are available). These are collected and analyzed by the apparatus and method according to the embodiment described above. The first, second and third data streams 301, 303, 305 are divided into a plurality of segments 307a, 307b, 307c, 307d, 307e, 307f . . . Each segment is given an overlap score 309a, 309b, 309c, 309d, 309e, 309f . . . In segment 307a, only the first data stream 301 is available. The overlap score 309a is 1. For segment 307a, the first segment of the first data stream 301 is selected for the summary 311a. In the next segment 307b, the overlap score 309b is 3, as all three data streams 301, 303, 305 are available. In this segment, 311b, the data stream having the best signal quality 303 is selected. For each segment and if overlap occurs, i.e. the overlap score is greater than 1, the signal quality of the data streams 301, 303, 305 are compared and the segment having the best signal quality is selected to form the summary. As a result, each participant receives the same video summary 311.

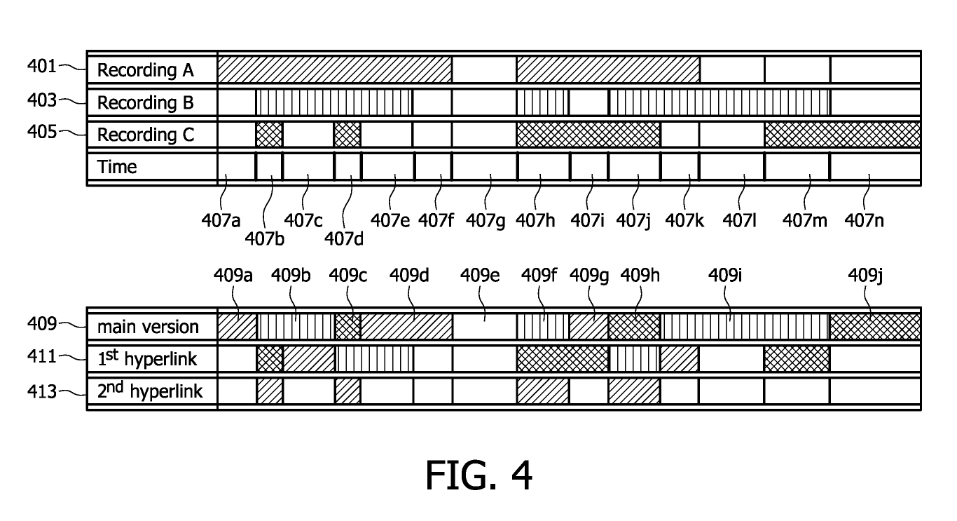

A slightly more sophisticated example is shown in FIG. 4, in which the different video streams are ranked according to best (signal) quality for each segment. When there are multiple streams at some point in time, the best video stream is shown as default, and hyperlinks to the other streams are provided. The order of the hyperlinks is based on the ranking of the video streams. In this way every participant gets access to all the video material available.

In the Example 2, first, second and third data streams 401, 403, 405 are available. These are collected and analyzed by the apparatus and method according to the embodiment described above. As in the previous example, the data streams 401, 403, 405 are segmented into a plurality of segments 407a, 407b, 407c, 407d, 407e, 407f . . . As described above, a default summary 409 of the recordings 401, 403, 405 is generated. Each segment 409a, 409b, 409c, 409d, 409e, 409f . . . comprises a selected segment of one of the data streams 401, 403, 405. For example, the first segment 409a comprises the first segment of the first recording 401 as this was the only data stream 401 available. For the segment 409b, the second segment of the second data stream 403 is selected. As there is overlap within this segment 407b between the first, second and third data streams, 401, 403, 405, one of the data streams is selected on the basis of signal quality, and each data stream 401, 403, 405 is ranked. Therefore, as an alternative to the second recording 403 being used for segment 407b, a first hyperlink 411 is provided which shows the third data stream 405 for segment 407b as this had the next best signal quality and a second hyperlink 413 which shows the first data stream 401 for the segment 407b. On highlighting these links, the user has the option of viewing these data streams for segment 407b as an alternative to the segment 409b provided for the default summary 409.

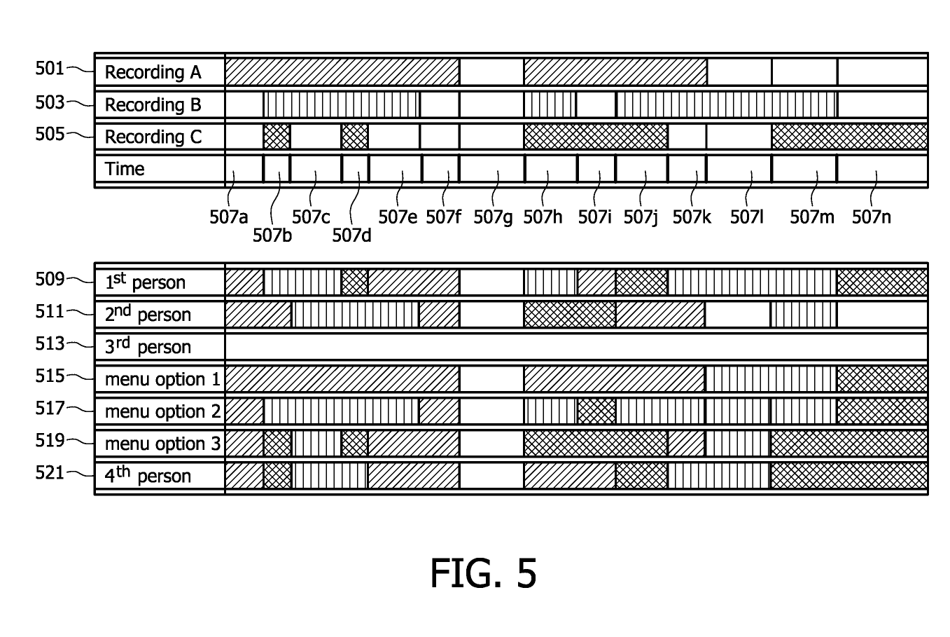

The embodiment of the present invention also allows for a more complex example as shown in FIG. 5. As previously mentioned, there are a number of participants at an event of which some have made recordings, which they send to the system of the present invention. The first person may always want the best physical quality available, the second person may prefer the video on which he/she and his/her family members are shown, the third person would like to have all the information available via menus, the fourth person doesn't care what video he/she gets, as long as he/she gets an impression of the event, etc. In this way there exist several personal profiles.

In this Example, first, second, third related data streams 501, 503, 505 are available. As described above with reference to the previous examples, these are collected and analyzed. Firstly, each of the first, second and third data streams 501, 503, 505 are segmented into a plurality of segments 507a, 507b, 507c, 507d, 507e, 507f . . . . A plurality of summaries 509, 511, 513, 515, 517, 519 are provided. The summary 509 comprises a combination of the “best” data streams i.e. a summary similar to summary 311 of FIG. 3 and the default summary 409 of FIG. 4. The second person had a preference for a recording having a particular content, for example, featuring particular participants at the event. The second summary 511 comprises the first data stream 501 for the time segments 507a, 507b. This is not the data stream which, necessarily, has the best signal quality but meets the participants preferred requirements. The third participant wants menu options. In this case three summaries 513, 515, 517 are provided showing three different combinations of summaries from which the participant can select the summary they prefer for their final summary. The fourth participant merely wanted an impression of the event. This final summary 519, for example, comprises the first data stream 501 for segment 507a and the third data stream 505 for segment 507b etc.

In the preferred embodiment above, the apparatus comprises a central (internet) server that collects and manipulates the raw data streams, and sends the final (personalized) summary back to the users. In an alternative embodiment, the apparatus comprises a peer-to-peer system in which the analysis (signal quality, face detection, overlap detection, redundancy detection, etc.) is performed on the capturing/recording devices of the users; the results are shared after which the needed recordings are exchanged. In yet a further alternative embodiment, the apparatus comprises a combination of the above embodiments in which part of the analysis is done on the user side, and another part at the server side.

The apparatus may also be implemented to process audiovisual streams of “live” cameras and combine these in real time.

Although preferred embodiments of the present invention have been illustrated in the accompanying drawings and described in the foregoing description, it will be understood that the invention is not limited to the embodiments disclosed but is capable of numerous modifications without departing from the scope of the invention as set out in the following claims.

1. A method of generating a summary of a plurality of distinct data streams, the method comprising the steps of:
synchronizing a plurality of related data streams, said data streams comprising a plurality of segments;
detecting overlapping segments of said synchronized data streams;
selecting one of said overlapping segments; and
generating a summary including said selected one of said overlapping segments.

2. A method according to claim 1, wherein said plurality of related data streams are synchronized in time or by a trigger.

3. A method according to claim 2, wherein said trigger is a change in at one least parameter of the data streams.

4. A method according to claim 2, wherein said trigger is generated externally.

5. A method according to claim 1, wherein the overlapping segments are detected as those segments that overlap in time.

6. A method according to claim 1, wherein the method further comprises the step of detecting redundancy of said overlapping segments.

7. A method according to claim 1, wherein selection is based on at least one of: signal quality of said segments, aesthetic quality of said segments, content of said segments, source of said segments and user preference.

8. A method according to claim 1 wherein said summary includes a plurality of selected segments and the method further comprises the step of:
normalizing at least one of the parameters of said selected segments included in said summary.

9. A method according to claim 1 wherein said data streams are video data streams.

10. A computer program product comprising a plurality of program code portions for carrying out the method according to claim 1.

11. Apparatus for generating a summary of a plurality of distinct data streams, the apparatus comprising:
synchronizing means for synchronizing a plurality of related data streams, said data steams comprising a plurality of segments;
detector for detecting overlapping segments of said synchronized data streams;
selection means for selecting one of said overlapping segments; and
means for generating a summary including said selected one of said overlapping segments.
